(19) United States
(12) Patent Application Publication
(10) Pub. No.: US 2008/0320211 A1
(43) Pub. Date: Dec. 25, 2008

(54) NONVOLATILE MEMORY CONTROL DEVICE, NONVOLATILE MEMORY CONTROL METHOD, AND STORAGE DEVICE

(75) Inventor: Tadaaki Kinoshita, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/143,221

(22) Filed: Jun. 20, 2008

(30) Foreign Application Priority Data
Jun. 22, 2007 (JP) 2007-165368

(51) Int. Cl. G06F 12/02; G06F 12/00; G06F 12/10

(52) U.S. Cl. 711/103; 711/104; 707/205; 707/E17.01; 711/E12.001; 711/E12.002; 711/E12.058

(57) ABSTRACT

According to an embodiment of the present invention is to increase the number of arbitrarily available physical blocks in a nonvolatile memory device. The device comprises a file system control section which analyzes a file allocation table (FAT) to identify an unused logical block, a logical/physical block address conversion table management section which uses a table of a logical/physical block address conversion table information section to obtain a first physical block corresponding to the unused logical block and releases the association between the first physical block and the unused logical block, and a physical block address information management section which registers the first physical block in a physical block address information section as an arbitrarily available second physical block.

### CROSS-REFERENCE TO RELATED APPLICATIONS

This application is based upon and claims the benefit of priority from Japanese Patent Application No. 2007-165368, filed Jun. 22, 2007, the entire contents of which are incorporated herein by reference.

### BACKGROUND

1. Field

One embodiment of the invention relates to a nonvolatile memory control device, a nonvolatile memory control method, and a storage device.

Particularly, the embodiments of the present invention are characterized in a nonvolatile memory management method that uses information of a file system to manage a logical block address-physical block address conversion table and an arbitrarily available physical block.

2. Description of the Related Art

A NAND-type flash memory is known as a data rewritable nonvolatile memory. The data erase unit of the nonvolatile memory is one block (e.g., 128 kbytes). On the other hand, the data read and write units of the nonvolatile memory are set to 2 kbytes. When the number of times of the erase or write operation is increased, device degradation occurs to result in an increase in occurrence of data errors. To cope with this, the number of times of write operations is set to, e.g., about one hundred thousand in order to guarantee the performance of the device. Accordingly, a function for managing the number of times of erasing a physical block is incorporated in a memory controller of the nonvolatile memory (refer to, e.g., Japanese Patent No. 3485938).

Further, there is proposed a method in which information of a FAT (File Allocation Table) is used to average the number of times of use of unused blocks (refer to, e.g., US 2006/0179263 (Y)).

In a conventional nonvolatile memory management method, the number of times of the erase operation is managed in physical blocks of the entire memory. Therefore, management of the physical block and averaging processing of the number of times of the erase operation are complicated and time-consuming.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration example of a storage device according to the present invention;

FIG. 2 is a view showing an example of a configuration of a file system;

FIG. 3 is a view for explaining an example of a FAT (File Allocation Table) shown in FIG. 2;

FIG. 4 is a view for explaining an example of a file chain shown in FIG. 3;

FIG. 5 is a view showing an example of file information stored in a folder area shown in FIG. 2;

FIG. 6 is a view showing an example of a logical/physical block address conversion table information section shown in FIG. 1;

FIG. 7 is a view showing an example of a physical block address information section shown in FIG. 1;

FIG. 8 is a flowchart explaining the basic operation of the device according to the present invention shown in FIG. 1;

FIG. 9 is a flowchart explaining an example of operation in the present invention at the time when a write command issued from a host shown in FIG. 1 is processed;

FIG. 10 is a subsidiary flowchart for explaining an example of operation in the device according to another embodiment of the present invention;

FIG. 11 is a view showing an example of a physical block erase count information section shown in FIG. 1;

FIG. 12 is a view showing, in chronological order, an example of information sent from the host; and

FIG. 13 is a view showing an example of the minimum size of the storage area to be provided on the nonvolatile memory device.

### DETAILED DESCRIPTION

Various embodiments according to the invention will be described hereinafter with reference to the accompanying drawings.

An object of the embodiments of the present invention is to provide a nonvolatile memory control device, a nonvolatile memory control method, and a storage device capable of increasing the number of arbitrarily available physical blocks in a nonvolatile memory device by using information of a file system, especially, information of a file allocation table and thus capable of facilitating and speeding up averaging processing (alternation between physical blocks) of the number of times of the physical block erase operation.

According to one aspect of the present invention, there is provided a nonvolatile memory control device comprising: a file system controller which analyzes a file allocation table (FAT) in a file system of a nonvolatile memory device to identify an unused logical block; a logical/physical block address conversion table management section which uses a table of a logical/physical block address conversion table information section to obtain a first physical block from a physical block address corresponding to the unused logical block and releases the association between the first physical block and the unused logical block; and a physical block address information management section which registers the first physical block in a physical block address information section as an arbitrarily available second physical block.

According to the above configuration, it is possible to easily detect a first physical block that has not frequently been used relative to other physical blocks based on information of the FAT. The detected first block is then registered in the physical block address information management section as an arbitrarily available second physical block, so that it is possible to maintain a large number of arbitrarily available physical blocks. Further, facilitation and speeding up of averaging processing (alternation between physical blocks) of the number of times of the physical block erase operation can be achieved.

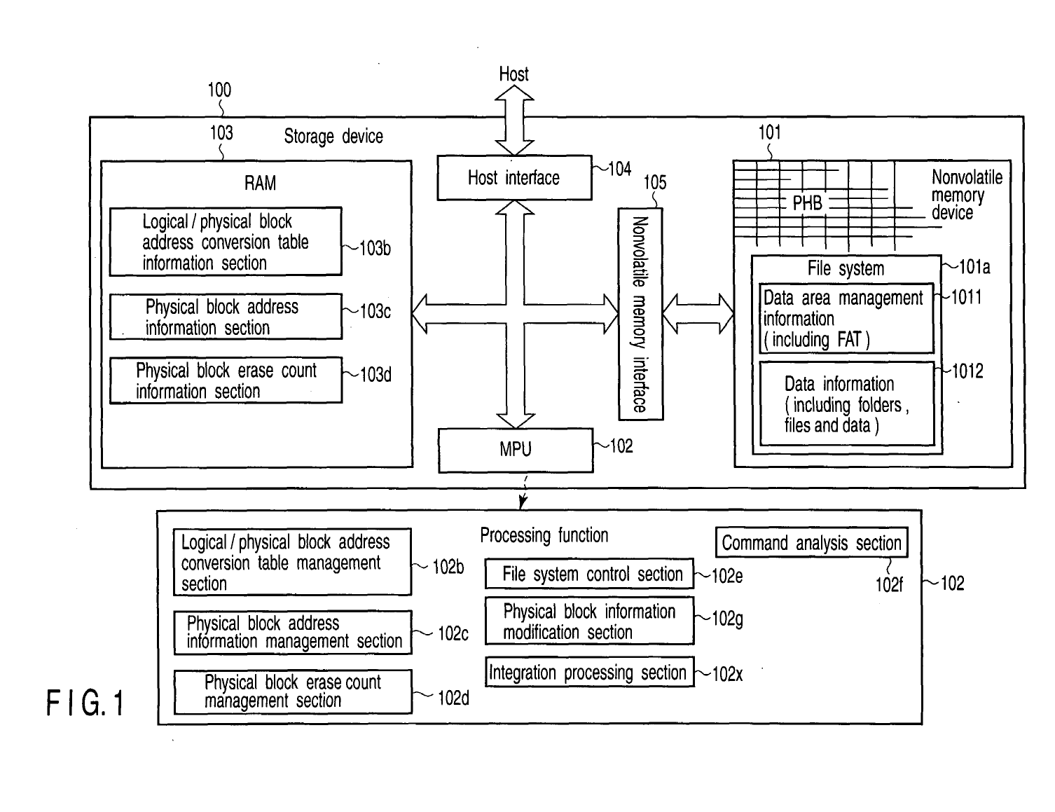

Hereinafter, embodiments of the present invention will concretely be described with reference to the accompanying drawings. First, a configuration of a storage device according to the present invention will be described using FIG. 1.

<Storage Device>

A storage device 100 includes a nonvolatile memory device 101, a micro processing unit (hereinafter, referred to as “MPU”) 102, a random access memory unit (hereinafter, referred to as “RAM”) 103, a host interface 104, and a nonvolatile memory interface 105.

The storage area of the nonvolatile memory device 101 is composed of a large number of physical blocks (PHB) and includes, in a part thereof, a file system 101a.

The file system 101a includes data area management information 1011 and a data area 1012. The data area management information 1011 includes a file allocation table (FAT). The data area 1012 includes a folder, file data, and the like.

The RAM 103 includes the following information sections as storage sections set therein: a logical/physical block address conversion table information section 103b having a table in which logical block addresses and physical block addresses are associated with each other; a physical block address information section 103c; and a physical block erase count information section 103d. Although not shown, an area in which a program executed by the MPU 102 is being run is ensured in the RAM 103.

The above logical block address refers to a logical block address of a logical address space utilized by a host. Further, the physical block address is a physical block address in the nonvolatile memory device 101.

The physical block address information section 103c registers arbitrarily available physical block addresses therein. In this case, for example, the physical block address information section 103c registers therein the physical block addresses that have not been associated with the logical block addresses. Alternatively, all physical block addresses may be registered together with identifiers indicating whether each physical block address is associated with the logical block address.

The physical block erase count information section 103d stores the erase count information of each physical block.

The table of the logical/physical block address conversion table information section 103b, address information of the physical block address information section 103c, and data of the physical block erase count information section 103d in the RAM 103 are managed and processed by the MPU 102.

Thus, the MPU 102 includes a logical/physical block address conversion table management section 102b, a physical block address information management section 102c, and a physical block erase count management section 102d.

Further, the MPU 102 includes a file system control section 102e that controls the file system in the nonvolatile memory device 101 and a physical block information modification section 102g. Although the physical block information modification section 102g may be included in the file system control section 102e, it is separately shown here for easy understanding. The physical block information modification section 102g erases the data in the physical block or corrects the physical block erase count. The corrected erase count is registered in the physical block erase count information section 103d under the control of the physical block erase count management section 102d. Further, the MPU 102 includes a command analysis section 102f.

Further, the MPU 102 includes an integration processing section 102x that controls the abovementioned management sections. The integration processing section 102x also performs data write/read operations.

The file system control section 102e can perform analysis and update of the file system. When analyzing the file system, the file system control section 102e checks the file allocation table (FAT) of each file in the folder. At this time, a part of the program stored in the RAM 103 is used to analyze the file system 101a. This analysis processing will be described later in more detail.

The logical/physical block address conversion table management section 102b controls a logical/physical block address conversion table to thereby grasp the physical block associated with the logical block.

<Basic Configuration of File System>

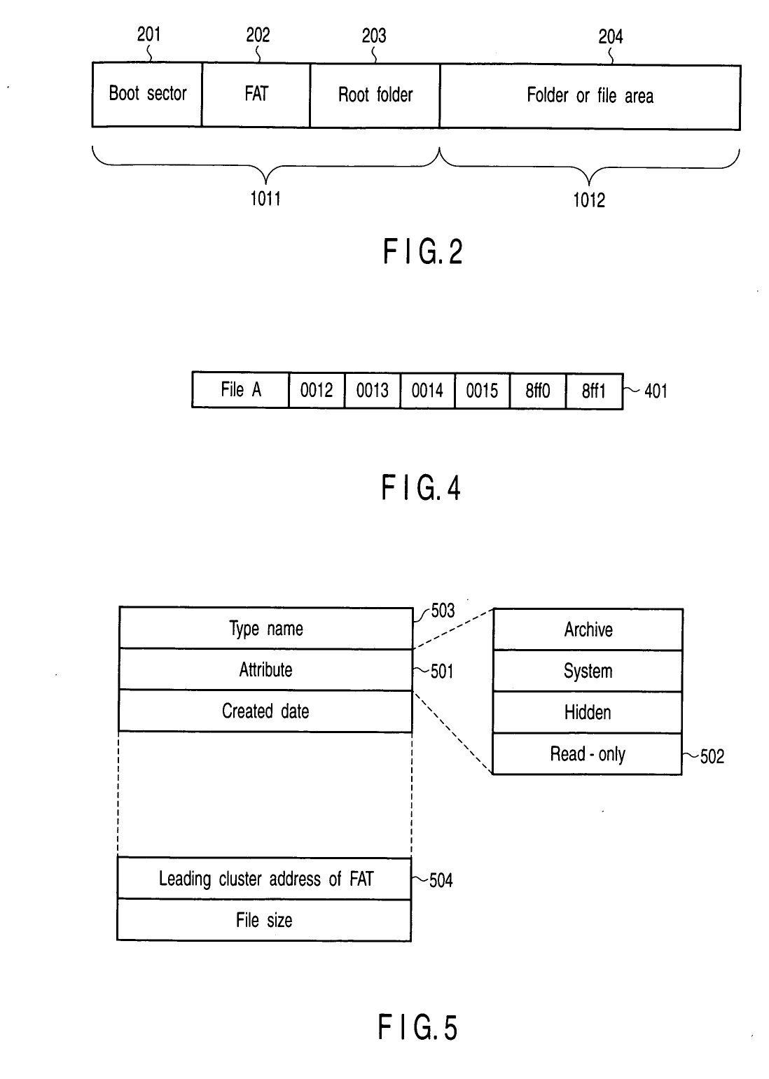

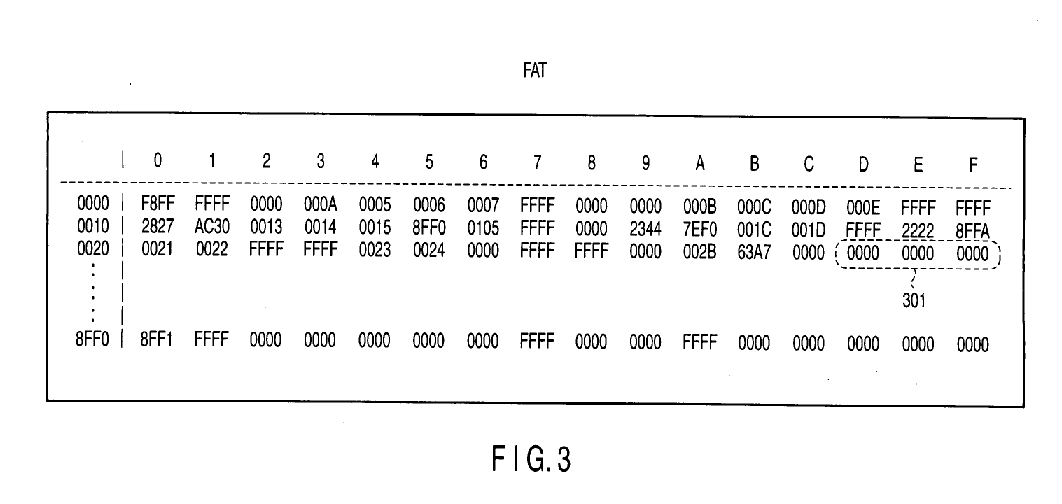

FIG. 2 is a view showing a configuration example of the file system. The data area management information 1011 stores information other than a data main body of a file, i.e., a boot sector 201, a FAT 202, and a root folder 203. Further, the data area 1012 includes a folder and/or a file 204.

<FAT and File Cluster Chain; FIGS. 3 and 4>

FIG. 3 shows an example of the FAT. FIG. 4 shows an example of a chain table of a file constituted by six clusters.

The FAT is a table showing a configuration of each file in units of data units called clusters, which are allocated to the data area 1012, as shown in FIG. 3.

It is assumed that a given file A is constituted by six clusters as shown by 401 of FIG. 4. The FAT data creates a cluster chain representing a plurality of cluster addresses constituting the file so that the cluster addresses are sequentially referred to, starting from the first cluster address constituting the file A.

Since the last cluster of the file has no chain, it shows “FFFFh”. Some table data represent special clusters. “0000h” is an unused cluster (for example, a part surrounded by a broken line 301 is arbitrarily available clusters), “F8FFh” is reservation system data. Two clusters correspond to one physical block (=one logical block).

<File Information in Folder>

One folder stores one or more files (one example is shown in FIG. 4). FIG. 5 is a view showing file information existing in each file in the folder. The file information includes type name information 503 in which file name information including an identifier is written, and file attribute information 501. The file attribute information 501 includes read-only information 502. Further, the file information includes the leading information (leading cluster address) 504 of the file chain of the FAT.

<Logical/Physical Block Address Conversion Table>

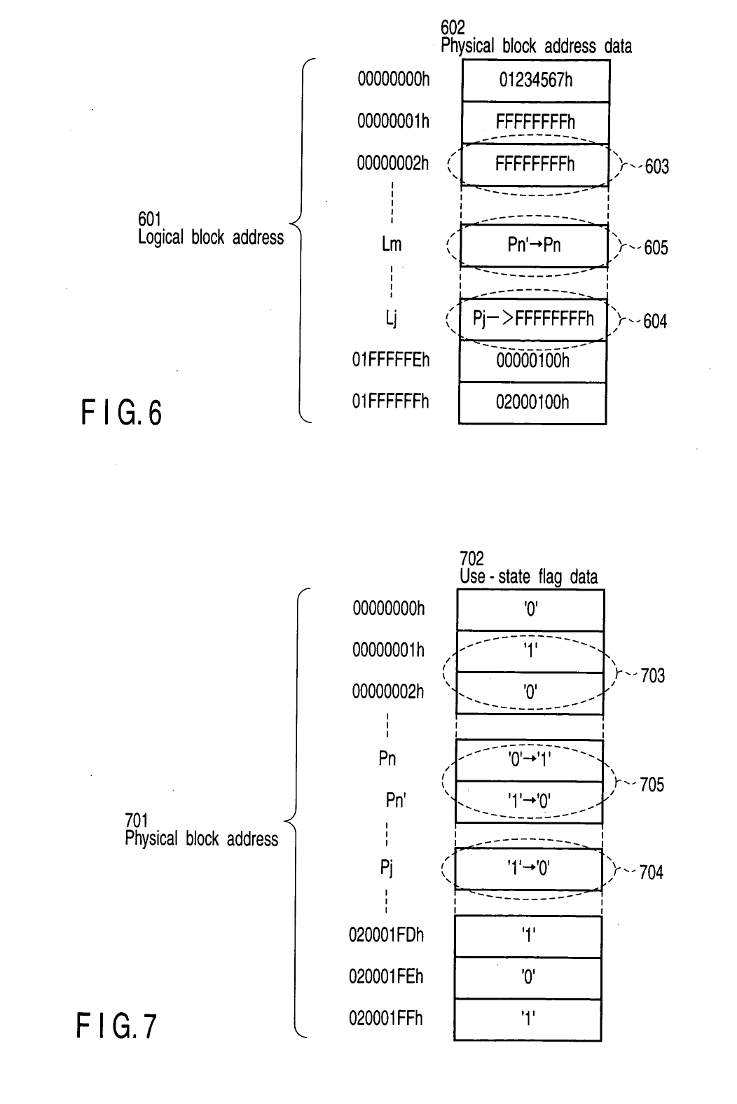

FIG. 6 is a view showing an example of the logical/physical block address conversion table of FIG. 1. A logical block address 601 corresponds to a 4-byte offset address starting from an arbitrary address on the RAM 103, and data section stores physical block address data 602 associated with the logical block address 601. FFFFFFFFh data 603 is stored in the data section of the logical block address with which the physical block has not been associated.

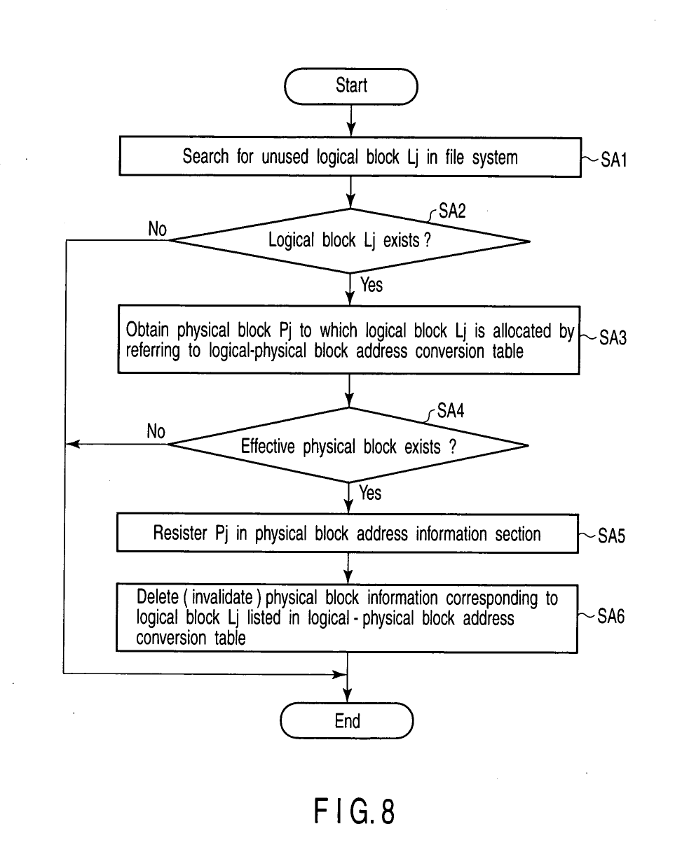

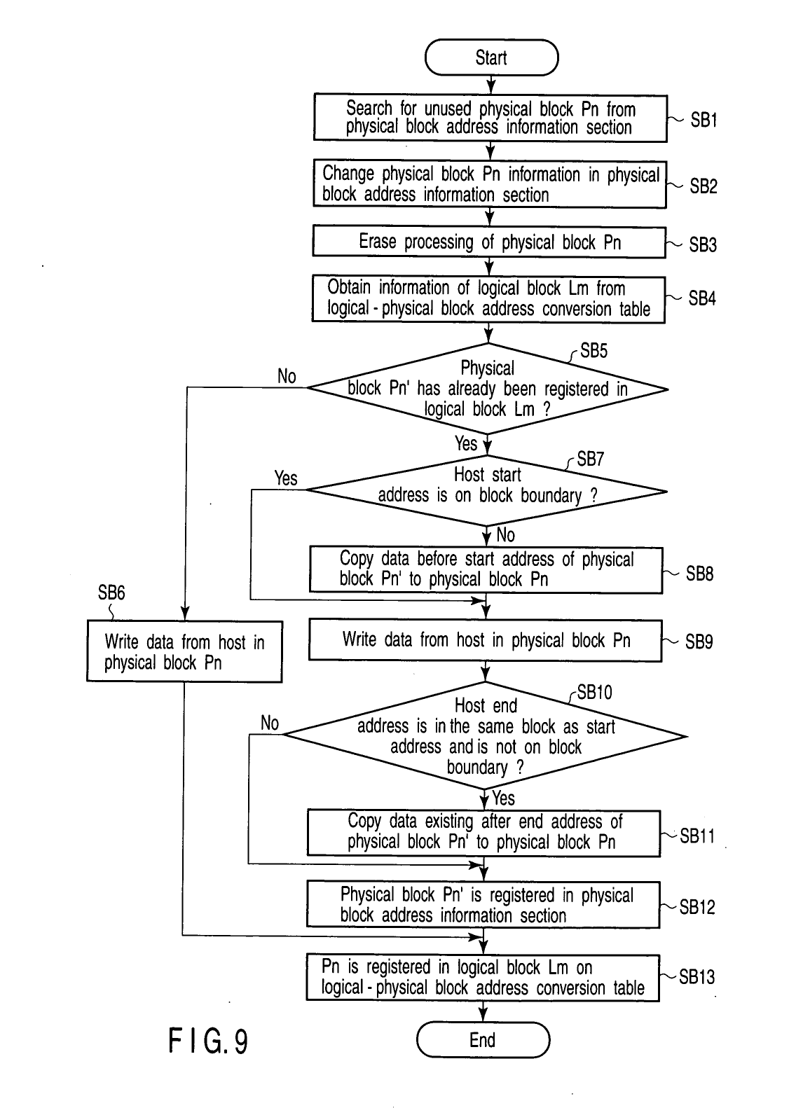

In step SA5 in FIG. 8 and step SB12 in FIG. 9 (to be described later), processing shown by 604 and 605 is respectively performed.

<Table in Physical Block Address Information Section>

FIG. 7 is the physical block address information section 103c, which shows an example of use state flag data therein. A physical block address 701 corresponds to a 1-bit offset address starting from an arbitrary address on the RAM 103, and this data section is constituted by 1-bit flag data 702 indicating the arbitrary availability.

The data section referred to by an arbitrarily available physical block address stores “0”, and the data section referred to by a given logical block address that is being used stores “1” (see reference numeral 703).

In step SA5 in FIG. 8 (to be described later), flag change is made as shown by a flag 704. That is, a state where a logical block address is allocated, i.e., a state where the corresponding physical block is being used is set. In step SB12 in FIG. 9 (to be described later), flag change is made as shown by a flag 705. That is, the flag corresponding to a physical block Pn′ that has entered an arbitrarily available state is changed from “1” to “0”, while the flag corresponding to a physical block Pn that has entered an in-use state is changed from “0” to “1”.

<Description of Basic Operation of Invention>

A part of the program stored in the RAM 103 is used to analyze the file system 101a. In the analysis of the file system 101a, an unused logical block Lj is searched for (step SA1). It is determined whether the Lj exists or not (step SA2). When the Lj does not exist, the flow ends. On the other hand, when it is determined in step SA2 that the Lj exists, a physical block Pj to which the logical block Lj is allocated is obtained by referring to the logical/physical block address conversion table (step SA3).

Then, it is determined whether an effective physical block Pj exists or not (step SA4). When the effective physical block Pj does not exist, this flow ends. On the other hand, when the effective physical block Pj exists, the physical block Pj is registered in the physical block address information section (step SA5). Then, association information between the physical block Pj and logical block Lj listed in the logical/physical block address conversion table 107 is released (step SA6). At this time, information of the physical block Pj is made empty for allowing a writing operation to be immediately made when the Pj is used next time. Further, at this time, the erase count information of the physical block Pj is updated.

<Description of Operation Performed in Response to Write Command from Host>

When a write command from the host is input through the host interface 104, an unused physical block Pn is searched for from the physical block address information section 103c (step SB1). Then, the physical block Pn information in the physical block address information section 103c is changed (to in-use state) and registered in the logical block Ln on the logical/physical block address conversion table (step SB2). Then, erase processing of the physical block Pn is performed (step SB3), and the address information of a logical block Lm for which the host performs a write operation is obtained from the logical/physical block address conversion table (step SB4).

When a physical block Pn′ has not been registered in the logical block Lm, the data from the host is written in a physical block Pn (steps SB5 and SB6). On the other hand, when the physical block Pn′ has already been registered in the logical block Lm, the flow proceeds to step SB7 where the existence of the data in the physical block Pn′ is confirmed.

That is, it is determined whether a host start address is in the same block as the start address and is not on the block boundary (step SB7).

When the host start address is in the same block as the start address and is not on the block boundary, the data existing before the start address of the physical block Pn′ is copied to the physical block Pn (step SB8). On the other hand, if the host start is on the block boundary, the step SB7 is skipped and the data from the host is written in the physical block Pn (step SB9). This prevents data from being left unprocessed.

Then, it is determined whether a host end address is in the same block as the start address and is not on the block boundary (step SB10). If the determination result is affirmative, the data existing after the end address of the physical block Pn′ is copied to the physical block Pn (step SB11).

At this time point, the physical block Pn′ is registered in the physical block address information section as an arbitrarily available physical block (step SB12). Further, the data of the physical block Pn′ is erased, and the erase count thereof is updated.

Then, the physical block Pn is registered in the logical block Ln on the logical/physical block address conversion table. When the amount of data to be write-accessed from the host exceeds one block, the operation starting from step SB1 is repeated.

<Example of Function that can Additionally be Provided>

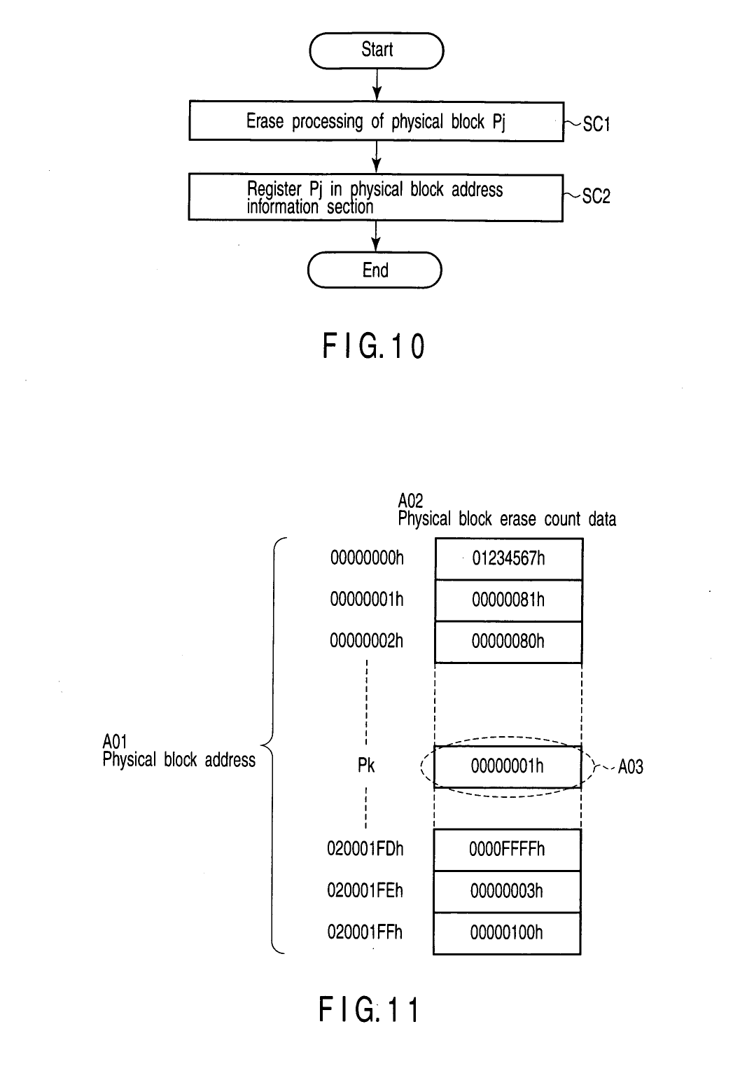

FIG. 10 is a subsidiary flowchart for explaining another example of operation according to another embodiment of the present invention. Before an arbitrarily available physical block address is registered in the physical block address information section 103c (step SC2), an erase operation is performed for the physical block (step SC1). This allows the step SB3 shown in FIG. 9 to be skipped, thereby reducing the processing time of FIG. 9, i.e., the write access time from the host.

<Erase Count Information Section>

FIG. 11 shows an example of the physical block erase count information section 103d. With this function, it is possible to increase the upper limit of the number of times of the rewrite operation in the entire device. The physical block erase count information section 103d stores, in units of blocks, data counting the number of times of the erase operation. The count value is used for selecting an appropriate physical block in step SB1 of FIG. 10. For example, in equalization of an erase/write operation, the count value is referred to for selecting a physical block for which the number of times of the erase/write operation is small.

A physical block address A01 corresponds to a 4-byte offset address starting from an arbitrary address on the RAM 103 and the data section stores erase count data A02 in units of physical block addresses. Assume that a physical block for which the number of times of an erase/write operation is small is selected in the example of FIG. 10. The erase count of a physical block address Pk shown by A03 is 1, so that if there is no physical block address the erase count of which is 0, the Pk can be a candidate.

<Setting of FAT Optimization Time Period>

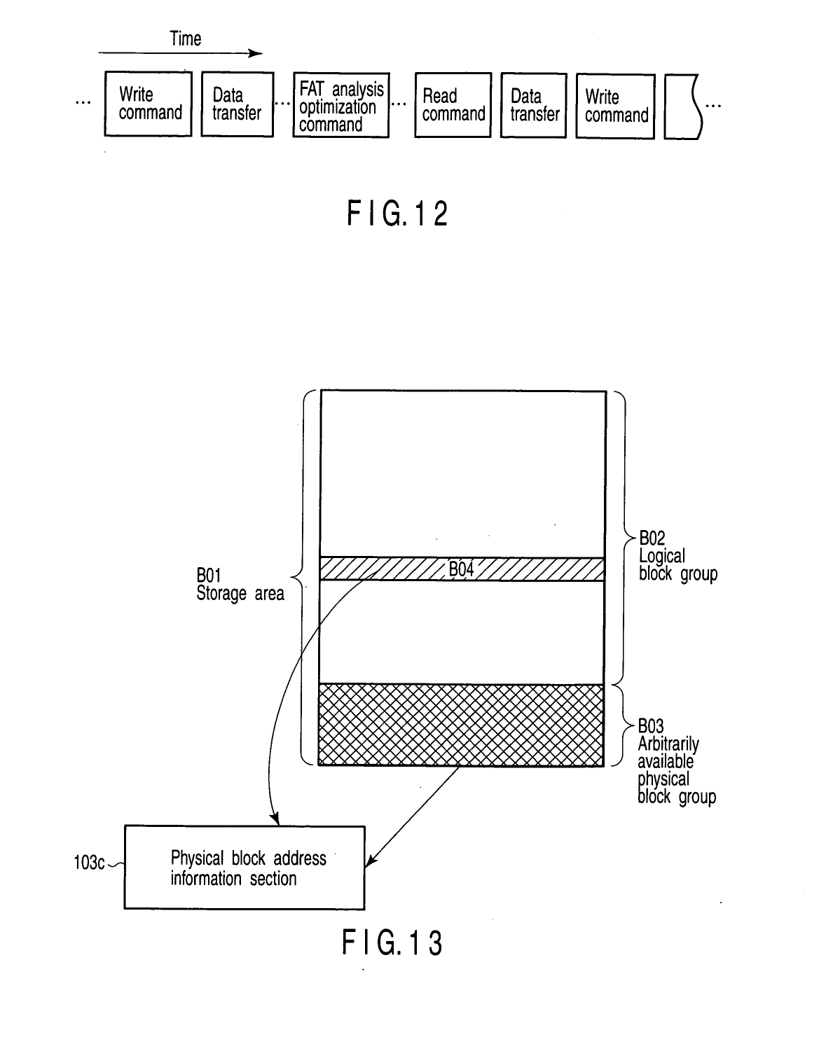

FIG. 12 is a view showing, in chronological order, an example of information sent from the host to the device according to the present invention. The time period of information sent from the host to the storage device 100 includes a write command time period, a data transfer period, a FAT analysis optimization command time period, a read command time period, a data transfer time period, etc. The FAT analyses optimization command time period is a time period during, which the operation shown in FIG. 8 is executed. The host is configured to issue a FAT analysis optimization command in the time period during which a data access operation need not be performed. Thus, the present invention can well be embodied.

<Example of Area on Nonvolatile Memory Managed by Logical/Physical Block Conversion Table>

FIG. 13 is a view showing an example of a state where the storage area on the nonvolatile memory device 101 is minimized. A storage area B01 on the nonvolatile memory device 101 is constituted by physical blocks and the most part thereof is associated with a logical block group B02 by the logical/physical block address conversion table information section 103b. However, in the non-volatile memory device 101 that cannot be overwritten, it is necessary to provide at least one block of an arbitrarily available physical block group B03 that cannot be associated with the logical block group B02. The storage area required for constituting the logical/physical block address conversion table information section 103b is the arbitrarily available physical block group B03 and an area required for registering a physical block B04 that can be added according to the present invention.

<Effectiveness of Embodiment and Modification>

An increase in the number of arbitrarily available physical blocks leads to an increase in the averaging processing of the number of times of the erase/write operation, thereby increasing the upper limit of the number of times of the rewrite operation in the entire device. This is effective for all storage products using a NAND-type nonvolatile memory as a main storage medium. Further, a management method of erasing the data of an arbitrarily available physical block can reduce the erase time of the physical block at the time when a data write command is issued from the host and reduce the redundant data write time accompanied by the data write operation from the host, thereby processing the write operation from the host at high speed.

The file system may be analyzed depending on the availability of the physical block address information section 103c. Then, an unused logical block is searched for, association between a physical block and the logical block on the logical/physical block address conversion table is released, and the physical block is stored in the physical block address information section as an arbitrarily available physical block.

A configuration may be adopted in which the availability of the physical block address information section 103c is notified to the host and then the file system is analyzed by a command from the host. Then, an unused logical block is searched for, association between a physical block and the logical block on the logical/physical block address conversion table is released, and the physical block is stored in the physical block address information section as an arbitrarily available physical block.

In the case where an error, i.e., a bad block occurs in the write and erase operation for the physical block, an arrangement may be set up in which cancel information is added to the table of FIG. 7 and a registration in the table of FIG. 6 is kept deleted.

As described above, according to the present invention, a physical block in which data has once been written from the host and which has not been used in the file system due to update of the data area management information section can arbitrarily be used. Thus, by erasing the physical blocks, it is possible to reduce the erase time of the physical block at the time when a data write command is issued from the host, and reduce the redundant data write time accompanied by the data write operation from the host, thereby processing the write operation from the host at high speed.

Further, an increase in the number of arbitrarily available physical blocks leads to an increase in the averaging processing of the number of times of the erase/write operation, thereby increasing the upper limit of the number of times of rewrite operations in the entire device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A nonvolatile memory control device comprising:
a file system controller which analyzes a file allocation table (FAT) in a file system of a nonvolatile memory device to identify an unused logical block;
a logical/physical block address conversion table management section which uses a table of a logical/physical block address conversion table information section to obtain a first physical block from a physical block address corresponding to the unused logical block and releases the association between the first physical block and the unused logical block; and
a physical block address information management section which registers the first physical block in a physical block address information section as an arbitrarily available second physical block.

2. The nonvolatile memory control device according to claim 1, comprising a physical block information correction section which erases the data of the first physical block when the first physical block is registered in the physical block address information section as the arbitrarily available second physical block.

3. The nonvolatile memory control device according to claim 1, wherein
the file system controller starts operating in response to a command from a host.

4. The nonvolatile memory control device according to claim 1, wherein
the physical block address information section is provided in a RAM which is used as a buffer.

5. The nonvolatile memory control device according to claim 1, wherein
the physical block address information section is provided as a table that can be referred to by the address of the first physical block.

6. The nonvolatile memory control device according to claim 1, wherein
when the logical/physical block address conversion table management section selects one physical block from arbitrarily available physical blocks registered in the physical block address information section (103c) so as to associate the selected physical block with a logical block, physical block erase count information is referred to for the selection.

7. A nonvolatile memory control method which controls a nonvolatile memory device including a file system using a random access memory in which a logical/physical block address conversion table and physical block address information including information indicating whether a physical block is in a use state or not are recorded and a micro processing unit which performs integrated control, the method comprising:
analyzing a file allocation table (FAT) in the file system to identify an unused logical block;
using the logical/physical block address conversion table to obtain a first physical block from a physical block address corresponding to the unused logical block and releasing the association between the first physical block and the unused logical block; and
registering the first physical block in the physical block address information as an arbitrarily available second physical block.

8. The nonvolatile memory control method according to claim 7, comprising erasing the data of the first physical block when the first physical block is registered in the physical block address information section as the arbitrarily available second physical block.

9. The nonvolatile memory control method according to claim 7, wherein
the analysis of the file allocation table is executed in response to a command from the host.

10. The nonvolatile memory control method according to claim 7, wherein
when one physical block is selected from arbitrarily available physical blocks registered in the physical block address information so as to associate the selected physical block with a logical block, physical block erase count information is referred to for the selection.

11. A storage device provided with:
a host interface which receives data including a command from a host
a random access memory;
a nonvolatile memory device; and
a micro processing unit which analyzes the command and integrally controls the random access memory and nonvolatile memory device,
the storage device comprising:
a file system controller which analyzes a file allocation table (FAT) in a file system of the nonvolatile memory device to identify an unused logical block;
a logical/physical block address conversion table management section which uses a table of a logical/physical block address conversion table information section to obtain a first physical block from a physical block address corresponding to the unused logical block and releases the association between the first physical block and the unused logical block; and
a physical block address information management section which registers the first physical block in a physical block address information section as an arbitrarily available second physical block.

12. The storage device according to claim 11, comprising a physical block information correction section which erases the data of the first physical block when the first physical block is registered in the physical block address information section as the arbitrarily available second physical block.

13. The storage device according to claim 11, wherein
the file system controller starts operating in response to a command from a host.
